(19) United States
(12) Patent Application Publication
(10) Pub. No.: US 2026/0292904 A1
(43) Pub. Date: Sep. 24, 2026

(54) SYSTEMS AND METHODS FOR U2U RELAY STATE DETECTION DURING DISCOVERY

(71) Applicant: InterDigital Patent Holdings, Inc., Wilmington, DE (US)

(72) Inventors: Taimoor ABBAS, Sainte-Julie (CA); Samir FERDI, Kirkland (CA); Michelle PERRAS, Montreal (CA); Jung Je SON, Warrington, PA (US); Magurawalage Chathura Madhusanka SARATHCHANDRA, London (GB)

(73) Assignee: InterDigital Patent Holdings, Inc., Wilmington, DE (US)

(21) Appl. No.: 19/472,060

(22) PCT Filed: Apr. 8, 2024
(86) PCT No.: PCT/US2024/023573

§ 371 Date: Oct. 2, 2025

Related U.S. Application Data
(60) Provisional application No. 63/457,586, filed on Apr. 6, 2023.

(51) Int. Cl. H04W 76/14; H04W 8/00; H04W 12/08; H04W 88/04; H04W 92/18

(52) U.S. Cl. CPC H04W 76/14; H04W 8/005; H04W 12/08; H04W 88/04; H04W 92/18

(57) ABSTRACT

A method performed by a first WTRU may comprise: receiving, from a network, one or more RSCs, wherein each of the one or more RSCs include a network assistance security indicator; selecting, from the one or more RSCs, a first RSC, wherein the selection of the first RSC is based on a first network assistance security indicator associated with the first RSC and a network coverage status of the first WTRU; on a condition that the network coverage status of the first WTRU is out-of-coverage, transmitting, to a second WTRU, a discovery message, the discovery message including the first RSC; and receiving, from the second WTRU, a DCR message, wherein the DCR message includes a second RSC. The first WTRU may be a relay WTRU and the second WTRU may be a source WTRU. The second RSC may be the same as the first RSC.

### CROSS-REFERENCE TO RELATED APPLICATIONS

This application claims the benefit of U.S. Provisional Application No. 63/457,586, filed Apr. 6, 2023, the contents of which are incorporated herein by reference.

### BACKGROUND

Direct and WTRU-to-Network Discovery Security procedures are specified in certain wireless standards. In particular, restricted discovery messages are protected for integrity, confidentiality and from replay using security material respectively associated with a ProSe restricted code and RSC. The protection against replay is done using a UTC-time based mechanism to ensure the freshness of the discovery message protection.

For direct discovery, a WTRU may be provided with security material associated with a ProSe restricted code by a Direct Discovery Name Management Function (DDNMF). For, WTRU-to-Network Discovery, the end WTRUs/and relay WTRU may be provided with security material associated with a RSC by a DDNMF or a Policy Control Function (PCF) or a ProSe Key Management Function (PKMF).

For 5G ProSe WTRU-to-WTRU Relay Discovery, both model A and model B discovery is supported. Model A uses a single discovery protocol message (Announcement) and Model B uses two discovery protocol messages (Solicitation and Response). The procedures for 5G ProSe WTRU-to-WTRU Relay Discovery with Model A and Model B are defined in 3GPP wireless standards.

5G ProSe communication via a 5G ProSe WTRU-to-WTRU relay with discovery integrated into PC5 unicast link establishment procedure is supported. The link establishment procedure using integrated discovery does not need the standalone discovery to be run. The detailed procedure is defined in 3GPP wireless standards.

### SUMMARY

A method performed by a first WTRU may comprise: receiving, from a network, one or more relay service code (RSCs), wherein each of the one or more RSCs include a network assistance security indicator; selecting, from the one or more RSCs, a first RSC, wherein the selection of the first RSC is based on a first network assistance security indicator associated with the first RSC and a network coverage status of the first WTRU; on a condition that the network coverage status of the first WTRU is out-of-coverage, transmitting, to a second WTRU, a discovery message, the discovery message including the first RSC; and receiving, from the second WTRU, a direct communication request (DCR) message, wherein the DCR message includes a second RSC. The first WTRU may be a relay WTRU and the second WTRU may be a source WTRU. The second RSC may be the same as the first RSC.

A method performed by a first WTRU may comprise: receiving, from a network, one or more relay service code (RSCs), wherein each of the one or more RSCs include a network assistance security indicator; receiving, from a second WTRU, a discovery message, the discovery message including a first RSC; and transmitting, to the second WTRU, a direct communication request (DCR) message, the DCR message including a second RSC. The first WTRU may be a source WTRU and the second WTRU may be a relay WTRU. The second RSC may be the same as the first RSC.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a state indication procedure during discovery;

FIG. 3 illustrates an example of a WTRU relay state detection procedure without standalone discovery;

FIG. 4 illustrates an example of a security establishment procedure between a target WTRU and relay WTRU;

FIG. 5 illustrates an example of a procedure performed by a WTRU; and

FIG. 6 illustrates an example of a procedure performed by a WTRU.

### DETAILED DESCRIPTION

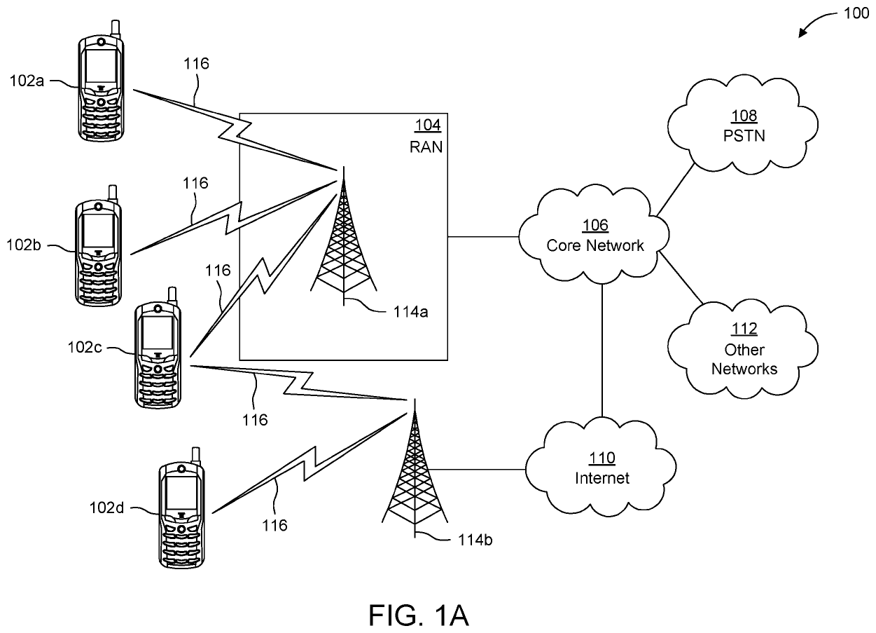

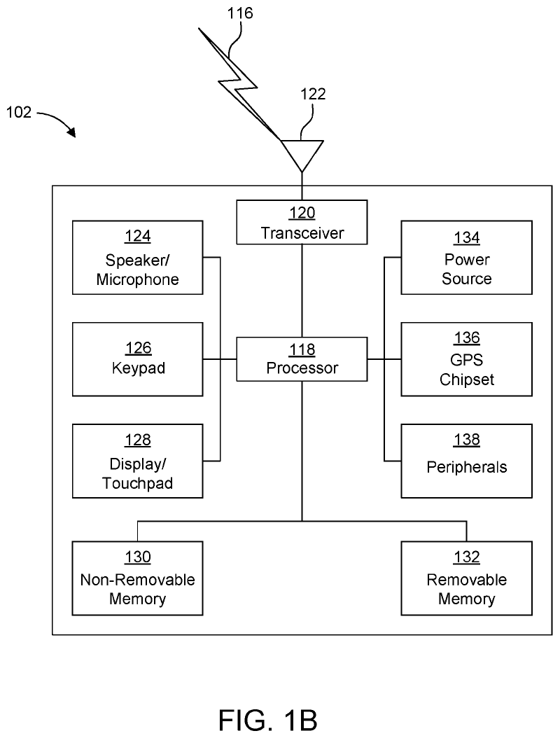

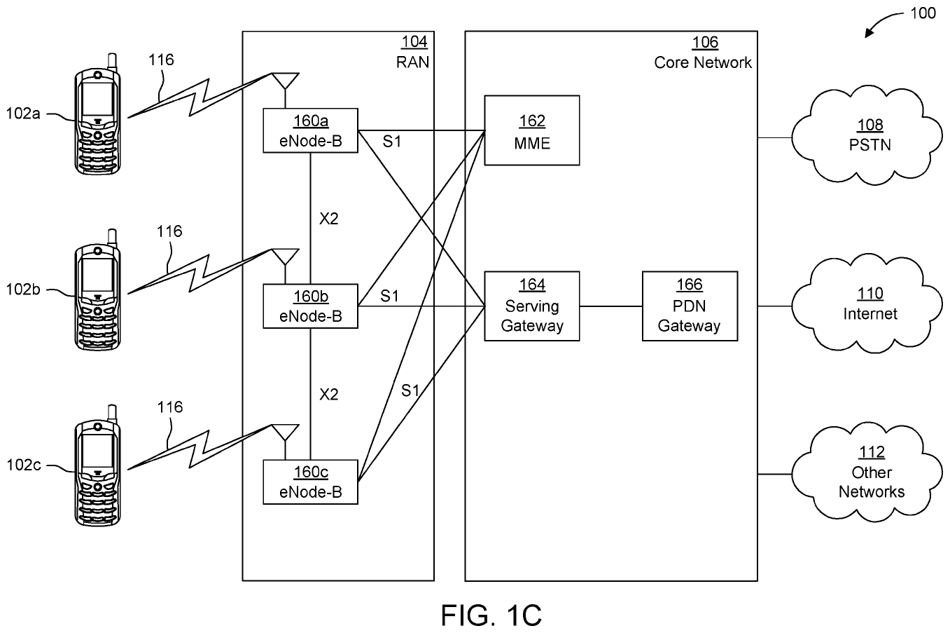

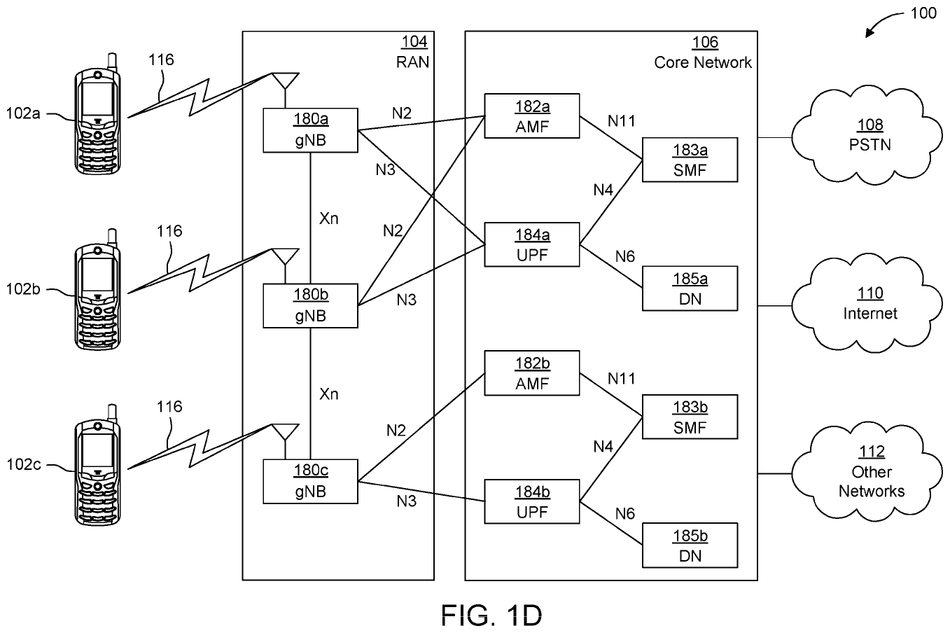

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms may be referred to:
CP Control Plane
DCR Direct Communication Request
DCA Direct Communication Accept
DCReject Direct Communication Reject
DDNMF Direct Discovery Name Management Function
IC In-coverage
OoC Out-of-Coverage
PRUK ID ProSe Remote User Key Identification
RSC Relay Service Code
SUCI Subscription Concealed Identifier
UP User Plane
U2U UE-to-UE
WTRU Wireless Transmit/Receive Unit

Hereinafter, the terms L3 U2U relay WTRU, L3 WTRU-to-WTRU relay WTRU, L3 U2U relay WTRU, U2U relay WTRU, relay WTRU, and relay may be used interchangeably. The term “end WTRU” may refer to the source WTRU and/or the target WTRU.

Certain 3GPP wireless standards addresses the 3GPP system requirements for security of a relay WTRU, which states that the 3GPP system has to be able to protect security (i.e., integrity and confidentiality) of information between the peer WTRUs over the relay WTRU, failure to comply this may open vulnerability in 5GS and allow various attacks such as unauthorized disclosure and modification of information. Protection of communications between the peer WTRUs assumes that the relay WTRU is a trusted node.

When the security is established between end WTRUs and a relay WTRU with the network assistance and the relay WTRU is in 5G network coverage then the security procedure is the same as the PC 5 security for 5G ProSe communication via 5G ProSe L3 WTRU to Network relay as defined in wireless standards.

There are two security mechanism options for 5G ProSe WTRU-to-Network relay: security procedure over User Plane (UP) as defined in certain 3GPP wireless standards and security procedure over Control Plane (CP) as defined in certain 3GPP wireless standards. The 5G ProSe remote WTRU and 5G ProSe WTRU-to-Network relay determine the security mechanism based on the Control Plane Security Indicator associated with the RSC, the Control Plane Security Indicator and the associated RSC are specified in certain 3GPP wireless standards.

3GPP wireless standards provide that the security procedures between end WTRUs and a relay WTRU with network assistance and without network assistance may be initiated using different parameters in the DCR message sent by an end WTRU and consequently use different security credentials used to establish the security (e.g., PRUK ID or SUCI vs KNRP ID/MSB of KNRP-sess ID). Accordingly, which parameters and security material to use to establish security between end WTRUs and the relay WTRU should consider the coverage status (i.e., IC or OoC) of the relay WTRU.

A security procedure that utilizes network assistance may require that the WTRU relay in-coverage. However, the end WTRU(s) may not able to know the coverage status of the relay WTRU (i.e., IC or OoC), because the mechanisms for the end WTRU to determine the be coverage status of the relay WTRU are not defined.

Accordingly, one problem is how to select the appropriate security procedure between end WTRU(s) and a relay WTRU. More specifically, the problem includes which security procedure should be performed between the source WTRU and the relay WTRU and which security procedure selection between the relay WTRU and the target WTRU. Another problem may be the procedure to enable the end WTRU to detect the coverage status of the relay WTRU.

In one embodiment, to detect the coverage status of the relay WTRU at the source WTRU, the relay WTRU may indicate its coverage status (i.e., IC or OoC and/or support for security with network assistance or security without network assistance) during a discovery procedure. Based on the coverage status of the relay WTRU and/or network assistance support indication, the source WTRU may select the correct security parameters for security establishment.

In another embodiment, when discovery is integrated into PC5 link establishment (i.e., without standalone discovery), the relay WTRU may send a direct communication reject (DCReject) message to an end WTRU if the received security parameters do not align with the current coverage status of the relay WTRU. The DCReject message may include a cause code indicating the coverage status of the relay WTRU.

In another embodiment, once the security with the source WTRU and the relay WTRU is established, the relay WTRU may send an indication (i.e., coverage status and/or network assistance support) in a DCR message to the target WTRU. The target WTRU, based on the indication, may initiate a security establishment (e.g., without network assistance) or send a DCReject message indicating that target WTRU may initiate the PC5 link establishment (e.g., using network assistance) with the relay WTRU.

In one embodiment the choice of security material may depend on whether the relay WTRU is IC or OoC. The state of the relay WTRU may be indicated to the end WTRUs during a discovery procedure. The indication of the coverage status of the relay WTRU (e.g., IC or OoC) is applicable for both model A and model B discovery procedures. The selection of security material during discovery may consider the state of both the end WTRUs and the relay WTRU for being IC or OoC.

In another embodiment, the network may need more control of the WTRUs and may prefer to use network assisted security procedure over the non-network assisted security procedure for those set of services. Accordingly, a preference associated with the RSC may be indicated by the network to the end WTRUs and to the relay WTRU that ensures network assisted security procedure will be used whenever the relay WTRU is in IC state. An indicator associated with the RSC may indicate whether security for communication with the relay WTRU is supported with network assistance or without network assistance or both.

In another embodiment the selection of the relay WTRU may be based on the coverage status of the relay WTRU (e.g., for the RSC where network assisted security is preferred, the relay WTRU is chosen by source WTRU only when the coverage status of the relay WTRU is indicated as IC). If there is no preference associated with the RSC for network assisted security, the source WTRU may learn the coverage status of the relay WTRU during discovery and use that information to select appropriate parameters for security establishment with the relay WTRU.

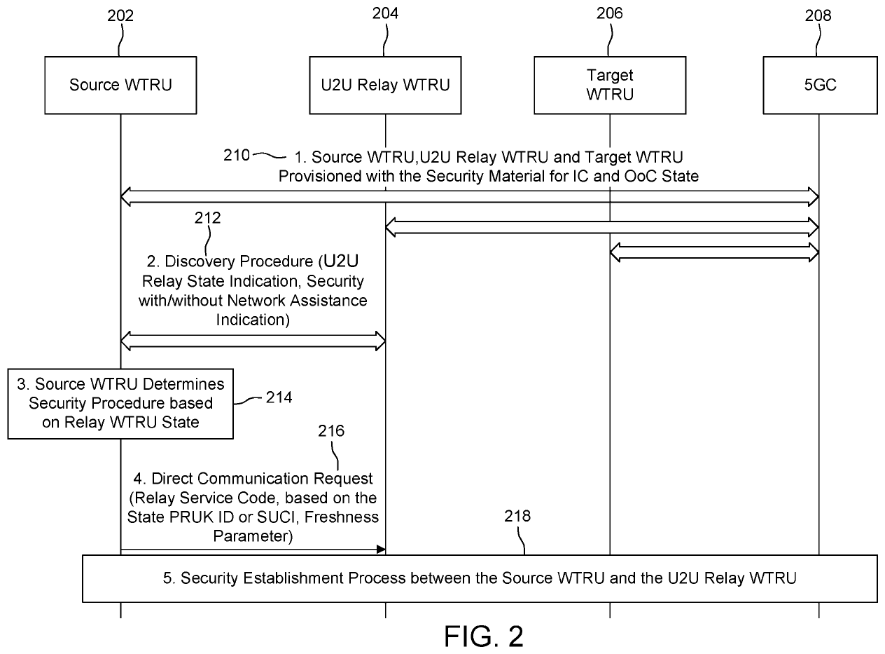

FIG. 2 illustrates an example of a state indication procedure 200 during discovery.

At 210, the source WTRU 202, relay WTRU 204, and target WTRU 206 may be provisioned with one or more RSCs that include a network assistance security indicator that indicates whether a security procedure with network assistance should be used or a security procedure without network assistance should be used. The source WTRU 202, relay WTRU 204, and target WTRU 206 may be provisioned with the security materials to support both IC and OC scenarios.

At 212, the relay WTRU 204, as part of a discovery procedure, may transmit its state indication (e.g., IC or OoC and/or with network assistant or without network assistance indicator) to the source WTRU 202. If model A is implemented, the relay WTRU state indication may be sent via discovery announcement message. If model B is implemented, the relay WTRU state indication may be sent via a solicitation response message that sent in response to the solicitation request received by the relay WTRU from the source WTRU 202.

At 214, the source WTRU 202 may learn or keep track of the state of the relay WTRU, including its coverage status, and may use the state of the relay to determine whether to connect with the relay WTRU 204 and which security procedure to perform if it does connect with the relay WTRU 204.

For example, if the relay WTRU 204 is IC, then the source WTRU 202 may initiate a network assisted security procedure. If the relay WTRU 204 is OoC, the source WTRU 202 may initiate OoC security procedures by transmitting, a PRUK ID or a SUCI (i.e., using PRUK as credential), a KNRP ID (if available), or KNRP ID/MSB of KNRP-sess ID (e.g., using provisioned long term credentials). For example, the source WTRU 202 may decide to select a different relay based on the preference associated with the RSC and the state of the relay WTRU 204 relay selection. For example, if the relay is OoC and RSC prefers network assistance, then the source WTRU 202 may not select that relay and instead, may select and/or look for a relay WTRU that is IC. In another example, the relay WTRU 204 may decide to stop announcing and/or replying to solicitation messages for an RSC that only supports network assistance when the relay WTRU 204 is OoC.

At 216, the source WTRU 202 may transmit, to the relay WTRU 204, a DCR message. The DCR message may include a RSC. The RSC may be the same RSC the source WTRU 202 received from the relay WTRU at 212. The DCR message may also, based on a previous security procedure determination, include security parameters for network assistance and/or security parameters for no network assistance. Upon receiving the DCR message, the relay WTRU 204 may transmit a DCReject message if the state of the relay WTRU 204 has changed (e.g., from IC to OoC by the time DCR message is sent by the source WTRU 202 and received at the relay WTRU 204 and the DCR includes parameters for network assistance). The source WTRU 202 may transmit a new DCR message with the correct security parameters (e.g., no network assistance), unless there is a preference associated to the RSC.

Following the DCR message, the PC5 link and security between the source WTRU 202 and the relay WTRU 204 may be established as defined in various 3GPP wireless standards.

If discovery is integrated into a PC5 link establishment (i.e., without standalone discovery), a source WTRU may know the state of a relay WTRU and if the source WTRU includes incorrect security parameters in the DCR message, the relay WTRU may send a DCReject message with a cause code indicating the coverage status of the relay WTRU and/or an indication that security parameters with network assistance or without network assistance is expected. Based on the cause code and/or the RSC indicator, the source WTRU may transmit the a new DCR message that includes appropriate parameters to the same relay.

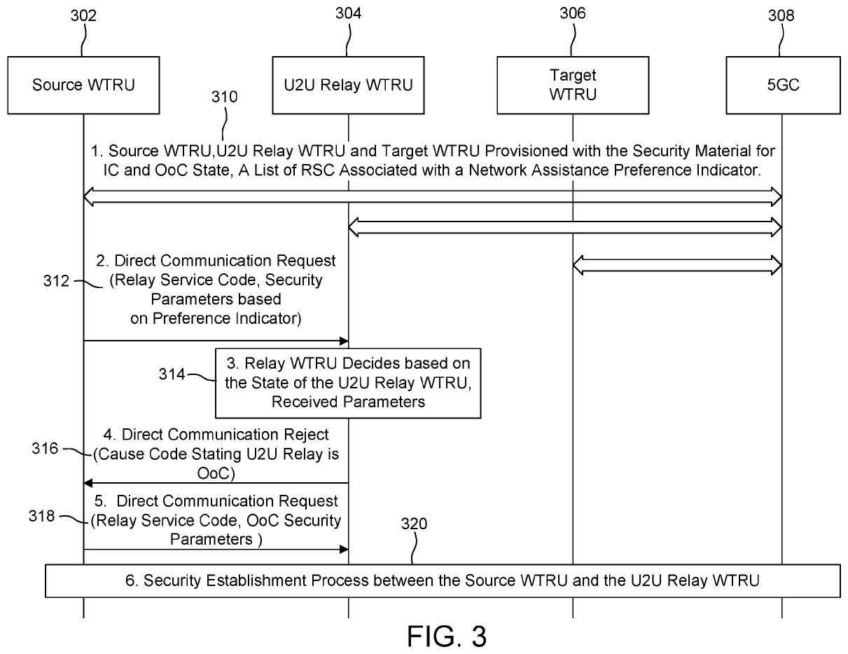

FIG. 3 illustrates an example of a relay WTRU state detection procedure without standalone discovery.

At 310, the source WTRU 302, relay WTRU 304, and target WTRU 306 may be provisioned with one or more RSCs that include a network assistance security indicator that indicates whether a security procedure with network assistance should be used or a security procedure without network assistance should be used. The source WTRU 302, relay WTRU 304, and target WTRU 306 may be provisioned with the security materials to support both IC and OoC scenarios.

At 312, the source WTRU 302 may transmit, to the relay WTRU 304, a first DCR message. The first DCR message may be based on a RSC with a security indicator security with or without a network assistance indicator (e.g., using parameters for network assistance, such as SUCI).

At 314, the relay WTRU 304 may determine to proceed with the next security establishment steps based on its coverage status and a RSC network assistance support configuration. For example, if the security parameter received is compatible with the coverage status of the relay WTRU and the RSC configuration of the relay (e.g., RSC supports network assistance while the relay is in coverage), then the relay WTRU 304 may proceed with conventional security establishment. Otherwise, the relay WTRU 304 may proceed according to the procedure described below.

At 316 the source WTRU 302 may receive a DCReject message from the relay WTRU 304. The DCReject message may includes a cause code indicating the coverage status of relay WTRU 304 and/or that security parameters with network assistance or without network assistance are expected (e.g., “the relay state is OoC” when network assistance support is expected).

At 318, the source WTRU 302 may transmit a second DCR message using parameters for security with network assistance or without network assistance based on the DCReject message and the cause code.

Alternatively, if there is more than one relay WTRU available in the range of the source WTRU 302, the source WTRU 302, after sending a first DCR message, may wait for time period before sending a new DCR message with different security parameters. For example, the source WTRU 302 may initiate a timer called a DCR resend timer. While the timer is running, the source WTRU 302 may receive a DCA message or DCReject message from one or more relay WTRUs that are in IC. If the source WTRU 302 receives a DCA message from a relay WTRU, the source WTRU 302 may stop the timer and may not send another DCR message. If the source WTRU 302 receives a DCReject message from a relay WTRU, the source WTRU 302 may resend, when the timer ends, a DCR message with security parameters based on the OoC indication from the relay WTRU.

At 320, following the second DCR message, the PC5 link and security between the source WTRU 302 and the relay WTRU 304 may be established as defined in various 3GPP wireless standards.

In one embodiment, network assistance may be used using control plane security (CP) procedure between the source WTRU and relay WTRU. For example, at 316, if procedure fails due to the CP procedure not being supported by the serving network, the relay WTRU 304 may send a DCReject message indicating that the source WTRU 302 transmit a second DCR message to the relay WTRU 304 using non-network assisted security parameters, instead of searching for another relay.

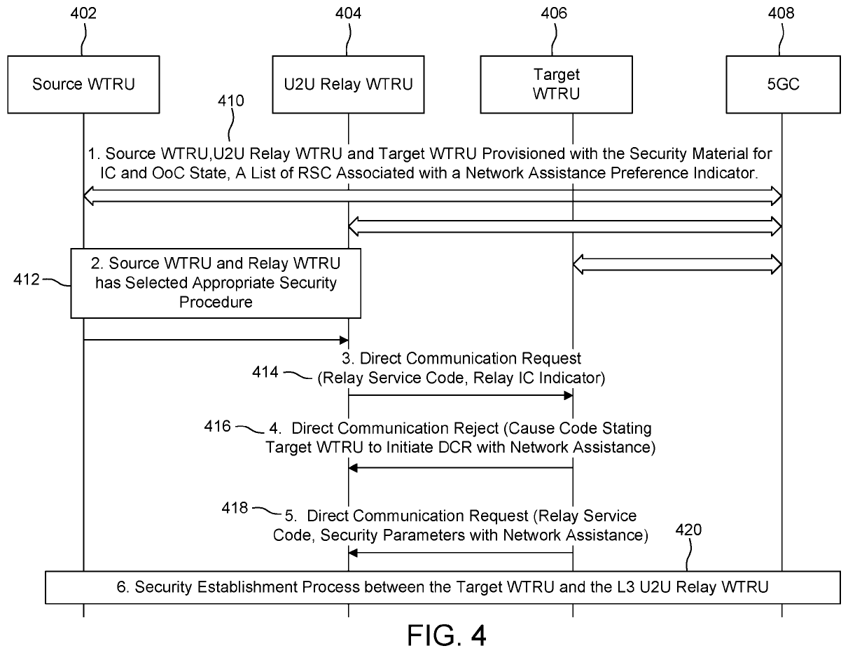

FIG. 4 illustrates an example of a security establishment procedure between a target WTRU and relay WTRU.

At 410, the source WTRU 402, relay WTRU 404, and target WTRU 406 may be provisioned with one or more RSCs that include a network assistance security indicator that indicates whether a security procedure with network assistance should be used or a security procedure without network assistance should be used. The source WTRU 402, relay WTRU 404, and target WTRU 406 may be provisioned with the security materials to support both IC and OoC scenarios. Alternatively, the list of RSC may include all RSCs with a preference order and associates states (e.g., IC, OoC or any other states).

At 412, the source WTRU 402 and relay WTRU 404 may select a security procedure (e.g. both are IC and there is network assistance preference indication for the RSC).

At 414, the relay WTRU 404 (which is in IC) may transmit a DCR message to the target WTRU 406. The DCR message may trigger a IC security procedure selection and may include an indication that the relay WTRU 404 is in coverage and/or a with network assistance or a without network assistance indicator.

At 416, the target WTRU 406 may send a DCReject message in response to the DCR message from the relay WTRU 404 with a cause code indicating that the target WTRU 406 may initiate a DCR. The relay WTRU 404 may start a timer for the reception of the expected new DCR from target WTRU 406.

At 418, the target WTRU 406 may transmit a DCR message and includes the security parameters relevant for network assisted security establishment.

At 420, following the DCR message, the security between the target WTRU 406 and the relay WTRU 404 may be established as described in various 3GPP wireless standards.

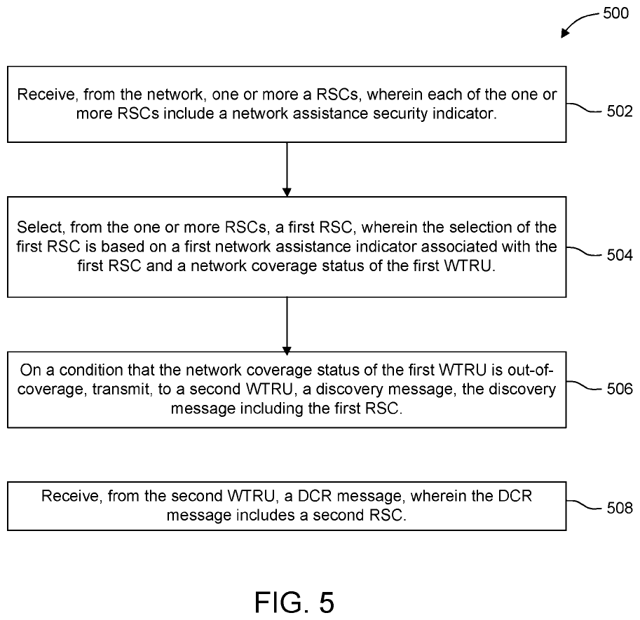

FIG. 5 illustrates an example of a procedure for a state indication during discovery. At 502, a first WTRU may receive from a network, one or more RSCs, wherein each of the one or more RSCs include a network assistance security indicator. At 504, the first WTRU may select, from the one or more RSCs, a first RSC, wherein the selection of the first RSC is based on a first network assistance security indicator associated with the first RSC and a network coverage status of the first WTRU. At 506, on a condition that the network coverage status of the first WTRU is out-of-coverage, the first WTRU may transmit, to a second WTRU, a discovery message. The discovery message may include the first RSC. At 508, the first WTRU may receive, from the second WTRU, a DCR message. The DCR message may include a second RSC, where the second RSC may be the same as the first RSC. The first WTRU may be a relay WTRU and the second WTRU may be a source WTRU.

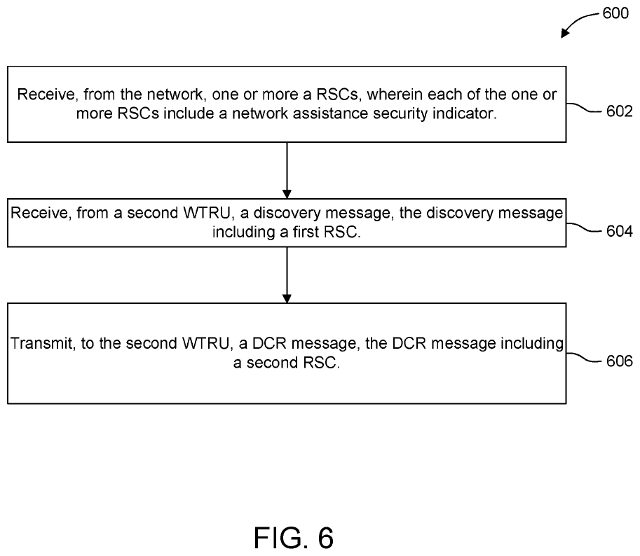

FIG. 6 illustrates an example of a procedure for a state indication during discovery. At 602, the first WTRU may receive, from a network, one or more relay service code (RSCs), wherein each of the one or more RSCs include a network assistance security indicator. At 604, the first WTRU may receive, from a second WTRU, a discovery message, the discovery message including a first RSC. At 606, the first WTRU may transmit, to the second WTRU, a direct communication request (DCR) message, the DCR message including the first RSC and security parameters, wherein the security parameters are based on the network assistance security indicator. The first WTRU may be a source WTRU and the second WTRU may be a target WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

1. A method performed by a first wireless/transmit receive unit (WTRU), the method comprising:
receiving, one or more relay service code (RSCs), wherein each of the one or more RSCs include a network assistance security indicator;
selecting, from the one or more RSCs, a first RSC, wherein the selection of the first RSC is based on: (i) a first network assistance security indicator associated with the first RSC and (ii) a network coverage status of the first WTRU;
transmitting, to a second WTRU, a discovery message including the first RSC, wherein, if the network coverage status of the first WTRU is out-of-coverage, the first network assistance security indicator is associated with a security procedure without network assistance; and
receiving, in response to the discovery message, from the second WTRU, a direct communication request (DCR) message.

2. The method of claim 1, wherein the first WTRU is a relay WTRU.

3. The method of claim 1, wherein the second WTRU is a source WTRU.

4. The method of claim 1, further comprising:
based on the first network assistance security indicator and the network coverage status of the first WTRU, accepting the DCR message.

5. The method of claim 1, wherein the DCR message includes a second RSC.

6. The method of claim 1, wherein the DCR message includes security parameters for a security procedure with network assistance.

7. The method of claim 1, wherein the DCR message includes security parameters for a security procedure without network assistance.

8. A first wireless/transmit receive unit (WTRU), comprising:
a processor; and
a transceiver;
wherein the processor and transceiver are configured to:
receive one or more relay service code (RSCs), wherein each of the one or more RSCs include a network assistance security indicator;
select, from the one or more RSCs, a first RSC, wherein the selection of the first RSC is based on: (i) a first network assistance security indicator associated with the first RSC and (ii) a network coverage status of the first WTRU;
transmit, to a second WTRU, a discovery message, including the first RSC, wherein, if the network coverage status of the first WTRU is out-of-coverage, the first network assistance security indicator is associated with a security procedure without network assistance; and
receive, from the second WTRU, a direct communication request (DCR) message.

9. The first WTRU of claim 8, wherein the first WTRU is a relay WTRU.

10. The first WTRU of claim 8, wherein the second WTRU is a source WTRU.

11. The first WTRU of claim 8, wherein the processor and transceiver are further configured to:
based on the first network assistance security indicator and the network coverage status of the first WTRU, accept the DCR message.

12. The first WTRU of claim 8, wherein the DCR message includes a second RSC.

13. The first WTRU of claim 8, wherein the DCR message includes security parameters for a security procedure with network assistance.

14-26. (canceled)

27. A first wireless/transmit receive unit (WTRU), comprising:
a processor; and
a transceiver;
wherein the processor and transceiver are configured to:
receive, from a second WTRU, a direct communication request (DCR) message, the DCR message including a relay service code (RSC), wherein the RSC includes a network assistance security indicator; and
transmit, to a second WTRU, based on the network assistance security indicator and a coverage status of the first WTRU, a direct communication reject message;
wherein the direct communication reject message includes a cause code.

28. The WTRU of claim 27, wherein the first WTRU is a relay WTRU.

29. The WTRU of claim 27, wherein the second WTRU is a source WTRU.

30. The WTRU of claim 27, wherein the coverage status of the first WTRU is in-coverage.

31. The WTRU of claim 27, wherein the coverage status of the first WTRU is out-of-coverage.
